(19) United States
(12) Patent Application Publication
(10) Pub. No.: US 2004/0046798 A1
(43) Pub. Date: Mar. 11, 2004

(54) Real estate presentation device and method

(76) Inventor: Arlene Alen, Lake Balboa, CA (US)

Correspondence Address: MILORD & ASSOCIATES, P.C., 10880 WILSHIRE BOULEVARD, SUITE 2070, LOS ANGELES, CA, 90024, US

(21) Appl. No.: 10/460,861

(22) Filed: Jun. 12, 2003

Related U.S. Application Data
(60) Provisional application No. 60/388,380, filed on Jun. 12, 2002.

(51) Int. Cl. G09G 5/00

(52) U.S. Cl. 345/777

(57) ABSTRACT

An interface on a computer system provides different presentation areas therein. The different presentation areas provide interrelated information regarding a specific real property. The data may include the combination of images, text, video and audio of a particular real estate for sale or rental, and provide the information over a communication network to a user interested therein.

### CROSS-REFERENCE TO RELATED APPLICATIONS

The contents of this application are related to a provisional application having serial No. 60/388,380 filed on Jun. 12, 2002, the contents of which are incorporated herein by reference.

### FIELD OF THE INVENTION

The invention relates to a device and method for the sale, lease, rental or portfolio of real estate, and in particular, relates to the combination of images, text, video and audio of a particular real estate for sale or rental, and providing the information over a communication network.

### BACKGROUND OF THE INVENTION

Real estate shopping previously involved the use of a real estate agent that would receive information from a buyer regarding the description of the property they wished to purchase. The agent would then search through listings that would possibly meet the buyer's requirement and relay the same to the buyer. The buyer and the agent would have to drive out to the location and physically inspect the same. After numerous visits, it is understandable that the buyer would quickly become frustrated with the process because of the temporal investment required.

Computer listing services are also now available that allow descriptions of the property and pictures of the same to be listed and available to the buyer. The computer listings may remove the factor of relaying information to the agent and awaiting the agent's interpretation of the property that the buyer is seeking. However, the buyer must spend many hours reading through property descriptions without receiving a true feel for the property. In addition, the information gathered from the listing may be limited and provide static photographs of only one perspective of the property or a room within the property.

For example, U.S. Pat. No. 6,397,208 to Lee discloses an interactive, Internet-based real estate service that has an integrated property searching service. The real estate service employs a database of real property listings and a user interface permitting users to define points-of-interest. The points-of-interest defined by a particular user are stored and used to calculate distances to properties selected from the property listings database. The distances can be presented in terms of linear distances or driving distances. In this manner, the user may interactively adjust his search criteria while observing how far the newly identified property listings are from the defined points-of-interest. However, Lee does not provide a dynamic real property display that allows a buyer to access differing views of the property, the floor plan, or the aerial views thereof.

The prior art does not address the need for a real estate display systems that is dynamic and efficient in disclosing relevant information and views of the subject property. Therefore, there remains a long-standing and continuing need for an advance in the art of real estate display systems that is efficient in both design and use, and is more effective in providing dynamic perspectives of the subject property.

### SUMMARY OF THE INVENTION

In view of the foregoing disadvantages inherent in the known types of real estate presentations now present in the prior art, a unique system and method for presenting real property to potential buyers or lessees is herein presented. The method of uploading information regarding a subject property may be conducted by the presenter or may be conducted by individuals hired by the presenter through the instant system. The presentation system allows for various views of the subject property to be viewed in one presentation window. In addition, a second presentation window may provide a thumbnail view of the alternate images that are available or may provide an architectural plan view. Furthermore, a third presentation window may present an aerial view of the subject property, wherein all of the subject presented in the various windows are presented in an interrelated manner such that selection of one view in one window provides a corresponding view in the two other windows.

Furthermore, besides presenting image files, video and audio files relating to the subject property may also be presented to the user in an interactive manner. Furthermore, contact information may be gathered from the user and files may be transmitted to the user through the Internet or recorded onto storage media and sent to the user.

Accordingly, it is a general object of the present invention to overcome the disadvantages of the prior art.

In particular, it is an object of the present invention to provide a system and method for presenting real estate to a user that is interactive.

It is another object of the present invention to provide a system and method for presenting real estate to a user that is dynamic.

It is another object of the present invention to provide a system and method for presenting real estate to a user that provides still or video images and audio files regarding the subject property.

It is yet another object of the present invention to provide a system and method for presenting real estate to a user that provides aerial views of the subject property.

It is a further object of the present invention to provide a system and method for presenting real estate to a user that correlates three different data sets regarding the subject property and provides the same to the user in an interrelated manner.

Such stated objects and advantages of the invention are only examples and should not be construed as limiting the present invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS

It is to be understood that the drawings are to be used for purposes of illustration only and not as a definition of the limits of the invention. In the drawings, wherein similar reference characters denote similar elements throughout the several views:

FIG. 1 is a flow diagram of the different options available to a client.

FIG. 2 is a representative display screen illustrating an interface system utilizing the teachings of the present invention.

FIG. 3 is a representative display screen illustrating a preferred image player utilizing the teachings of the present invention.

FIG. 4 is an alternate preferred embodiment illustrating the interface system utilizing the teachings of the present invention.

FIG. 5 illustrates an alternate view of the alternate preferred embodiment illustrating the interface system utilizing the teachings of the present invention.

### DESCRIPTION OF THE INVENTION

The detailed descriptions which follow are presented largely in terms of display images, algorithms, and symbolic representations of operations of data bits within a computer memory. These algorithmic descriptions and representations are the means used by those skilled in the data processing arts to most effectively convey the substance of their work to others skilled in the art.

An algorithm is here, and generally, conceived to be a self consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, images, terms, numbers, or the like. It should be borne in mind, however, that all of these and similar terms are to be associated with the appropriate physical quantities and are merely convenient labels applied to these quantities.

In the present case, the operations are machine operations performed in conjunction with a human operator. Useful machines for performing the operations of the present invention include general purpose digital computers or other similar devices. In all cases, there should be borne in mind the distinction between the method operations of operating a computer and the method of computation itself. The present invention relates to method steps for operating a computer and processing electrical or other physical signals to generate other desired physical signals.

The present invention also relates to apparatus for performing these operations. This apparatus may be specially constructed for the required purposes or it may comprise a general purpose computer selectively activated or reconfigured by a computer program stored in the computer. The algorithms presented herein are not inherently related to any particular computer or other apparatus. In particular, various general purpose machines may be used with programs in accordance with the teachings herein, or it may prove more convenient to construct more specialized apparatus to perform the required method steps.

In addition, in the following description, numerous specific details are set forth such as functional blocks representing data processing devices, metaphors, such as desktop and window metaphors, window configurations and arrangements, etc. in order to provide a thorough understanding of the present invention. However, it will be apparent to one skilled in the art that the present invention may be practiced without the specific details. In other instances, well known circuits and structures are not described in detail so as not to obscure the present invention unnecessarily.

The present invention provides a system and method for providing an interface for use in a computer display system to provide information related to a subject real property. The display system includes at least one central processing unit (CPU) which is coupled through appropriate input/output (I/O) circuitry to input devices, such as a keyboard, digital pad, mouse and/or track ball. The CPU is coupled to a hard disk drive for the storage of programs and data, and may also be coupled to a network through which the CPU may communicate with a variety of other system resources and devices. The CPU is further coupled to a display device such as a CRT or liquid crystal display, on which the present invention is displayed. The user interface of the present invention includes a graphic user interface which may have overlapping windows or sections within the same window that communicate therebetween. The present invention includes an access window having at least command options, icons, links and search functions for selection by a user. Through the use of at least the command options, icons, links and search functions, a real property inquiry may be defined.

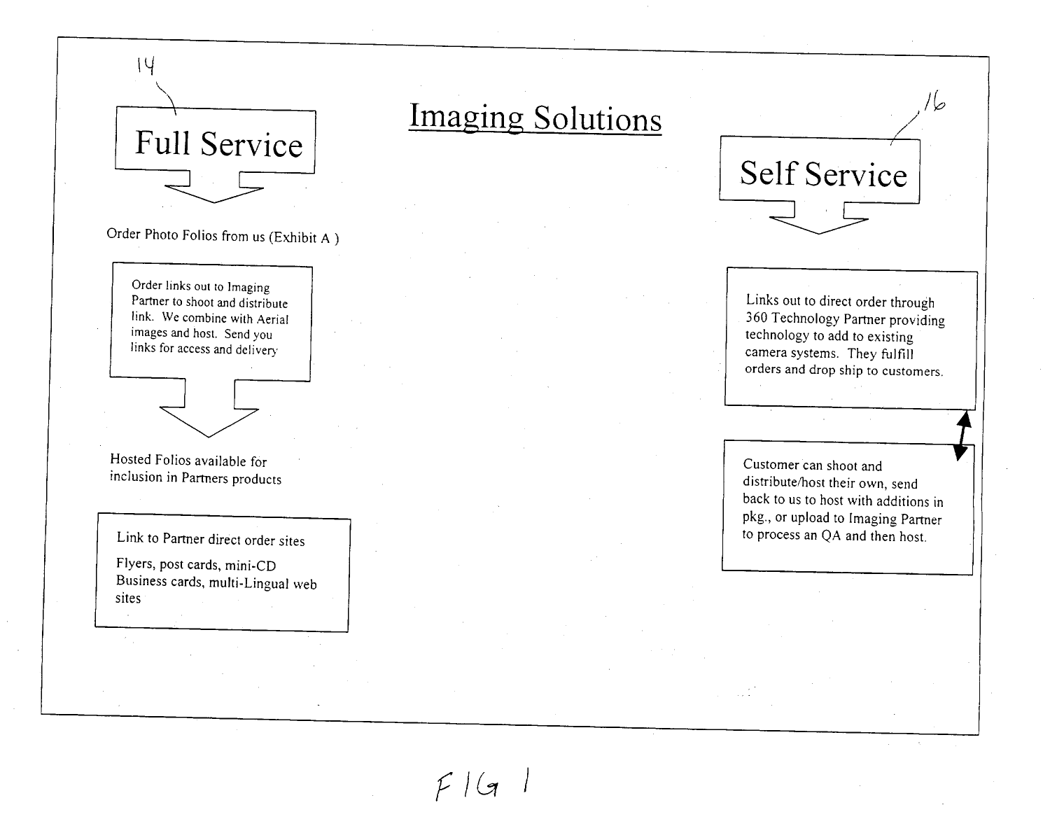

Referring to FIG. 1, one preferred system and method is illustrated wherein a client, which may be a property owner, seller, lessor, broker, bank, architect, portfolio manager, or other, who wishes to present the subject real estate to a user, which may be a potential purchaser, lessee, manager, banker, architect, broker, or other may select a full service option 14 or a self-service option 16 for presenting the information to users. If the full service option 14 is selected, an order is sent to an image provider that shoots still photographs or video of the subject real estate. The photographs or video may include a virtual tour of the interior and exterior of the subject property and also include aerial images of the property and surrounding neighborhood. The photographs or video may be hosted on a server of a site-owner for access by the public through a computer network or the images may be created into information packets, post cards, compact discs, mini-CD business cards and delivered to the client.

If the client selects the self-service option, the user may use their own equipment to upload information or a product supplier may deliver or ship the required photographic and/or video equipment to the client such that the client may themselves shoot the video or still shots of the subject property. The client, if computer savvy, may develop their own website or they may then be allotted a site on the server to host the information about the subject property in accordance with the provider's specification. Alternatively, the client may return the text, audio, still images, or video to the site-owner wherein the information is hosted for access by interested users.

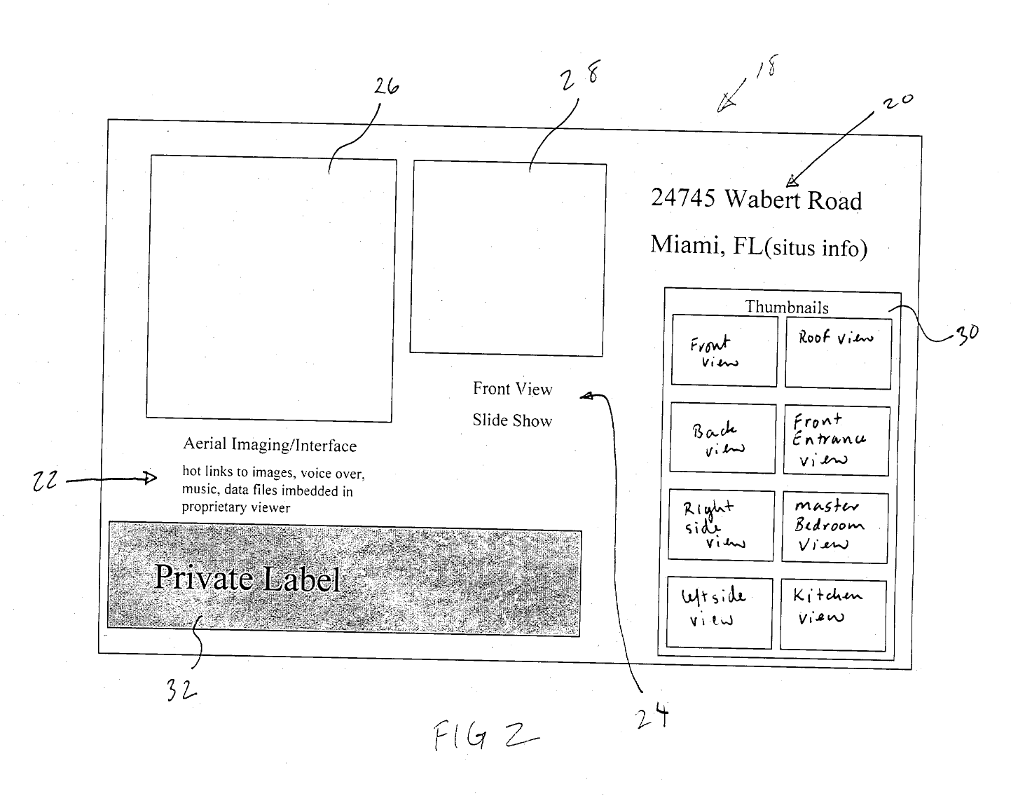

Now referring to FIG. 2, one preferred interface 18 is provided, for purposes of illustration but not limitation, for access by users. The subject property is identified through a first set of indicia 20, which may be the physical address of the subject property. A first set of command options 22 allow the user to access corresponding text, audio, images, and video files by depressing a mouse button while the cursor is on one of the command options 22. Alternatively, the first set of command options 22 may be provided in the form of a drop down menu which also allows the user to select the desired option.

A second set of command options 24 allow the user to select from the different views of the subject property or request a slide show of the different views of the subject property which are provided within the interface 18. A first presentation window 26 is provided within interface 18 and may be adapted to provide aerial photographs of the subject property. A second presentation window 28 may be provided within interface 18 and may be adapted to provide images of the subject views of the property in addition to a slide show of the same. A third presentation window 30 is provided within interface 18 and may have thumbnail images of the different views of the subject property. Upon selection of an individual thumbnail, the larger corresponding image may be presented within second presentation window 28, or an additional window in a separate plane may be opened wherein the corresponding image may be displayed without interfering with the display of interface 18. Additional information about the neighborhood may be provided such as, but not limited to, surrounding businesses, properties, schools, religious institutions, and post offices, within embedded first set of command options 22.

A customizing element 32 may also be provided on interface 18 and can denote a sponsor of the website where the interface appears. One preferred feature of a system for displaying the customizing element 32 is the use of “skins,” or customizable user interfaces that can be varied from operator to operator and can preferably be created and downloaded directly to the interface 18. To this effect, different skins will present different “controls” or parameters in differing graphical manners. Since a nearly infinite number of possible graphical displays may be used, skins are preferably written in software by others, located through the Internet, and are made selectively downloadable to individual interfaces 18 at the discretion of the provider or sponsor of the website. As new skins become available, a website owner or sponsor may select new skins or remove old skins. It should be emphasized that the aforementioned skins are hypothetical only and that, using simply software design utilities, individuals familiar with skins or with programming should be able to routinely design a wide variety of downloadable, skins for use in connection with the preferred embodiment.

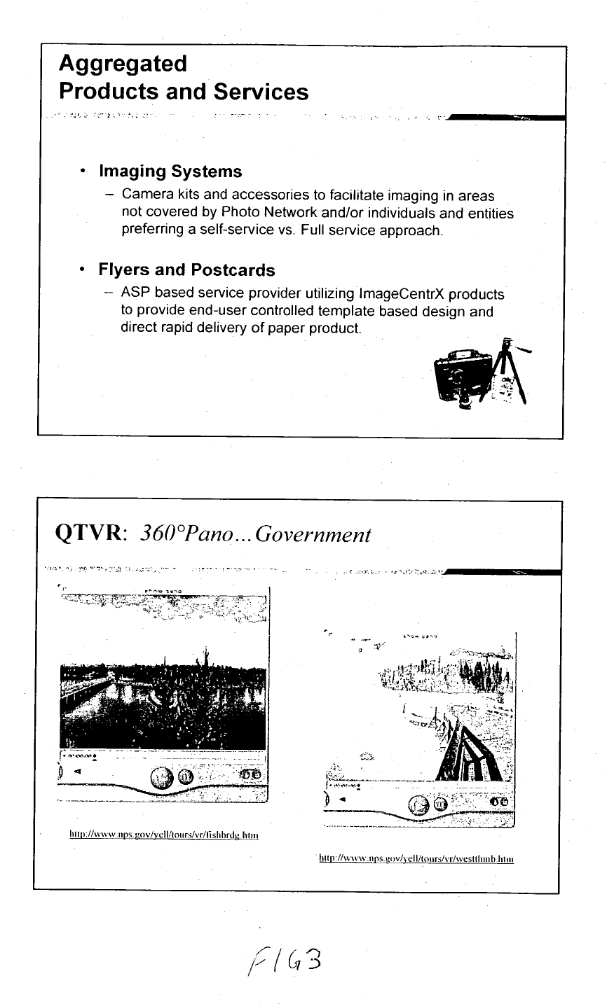

Now referring to FIG. 3, an image or video player, which are currently known in the art, may be embedded into interface 18 or may be opened as a separate window or interface for displaying moving images of the subject property. The immersive, panoramic, still and or video images option may be embedded as a command option 22, 24, or 26, or the image or video player may be permanently located within interface 18 such that the selection of a command option, such as a front view, would also command the video images to be displayed contemporaneously as the still image. The video images and promotional materials may be obtained through either the self-service or full service option and associated with or embedded in interface 18.

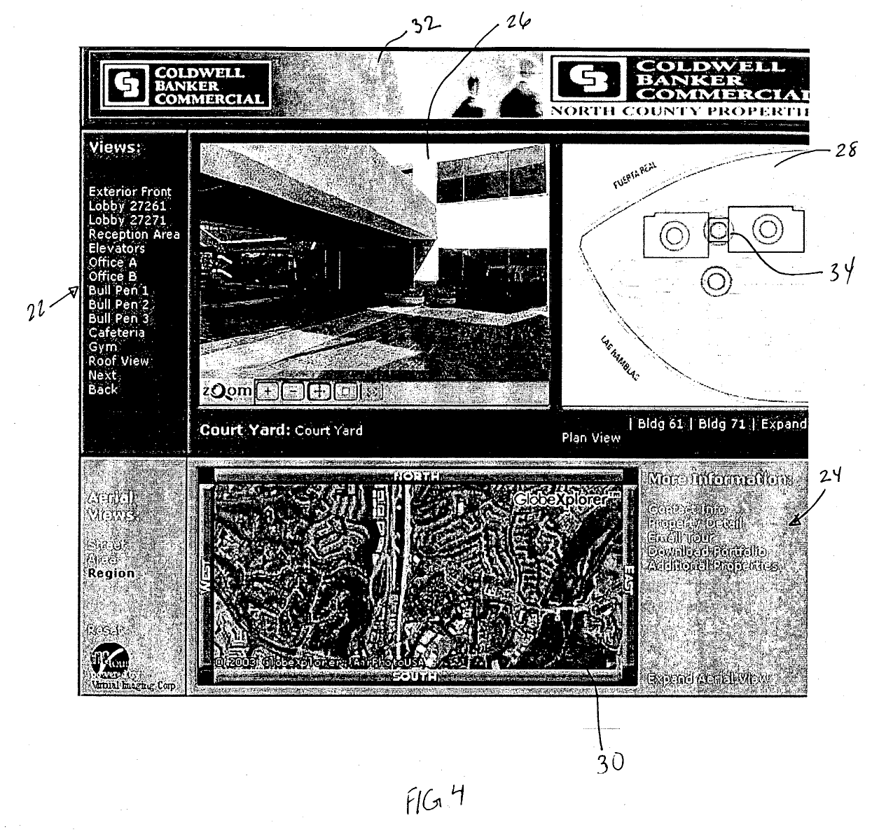

Now referring to FIG. 4, for purposes of illustration, but not limitation, an alternate preferred embodiment of the instant interface 18 is therein illustrated. First presentation window 26 presents an adjustable image of the view which may be selected by use of first set of command options 22. Second presentation window 28 presents an architectural plan of the subject property which interrelates to the view selected in the first set of command options 22. Accordingly, by selecting a specific view through first command options 22, the corresponding plan view is presented in second presentation window 28. In third presentation window 30, the aerial view of the subject property selected by a user is therein displayed. An indicator 34 may be presented in second window presentation 28 such that a user may orient themselves as to the location and direction of the view selected from first set of command options 22. A second set of command options 24 are also presented, whereby a plurality of commands may therein be displayed. For purposes of illustration, if “Contact Info” is depressed by a user, either the client's contact information may be provided to the user or a window may open to request the users contact information. If “Property Detail” option is selected by the user, information regarding the property such as, but not limited to, the year of construction, total square footage, parking availability, etc. may be provided to the user by means known in the art. If “Email Tour” option is selected, an e-mail program or an on-screen window may be opened and request the user's e-mail address such that a video file, image file, or text file may be electronically transmitted to the user's e-mail inbox. If “Download Portfolio” option is selected, an image portfolio will be provided as an executable file that may be accessed off-line or to be e-mailed to another party in that format. If “Additional Properties” is requested, the database storing such records will be sent a request for the information which shall be provided to the user. It is to be understood that the command options 24 herein presented are for purposes of illustration and not limitation. Additional options may be displayed or substituted therefor without departing from the essence of the invention.

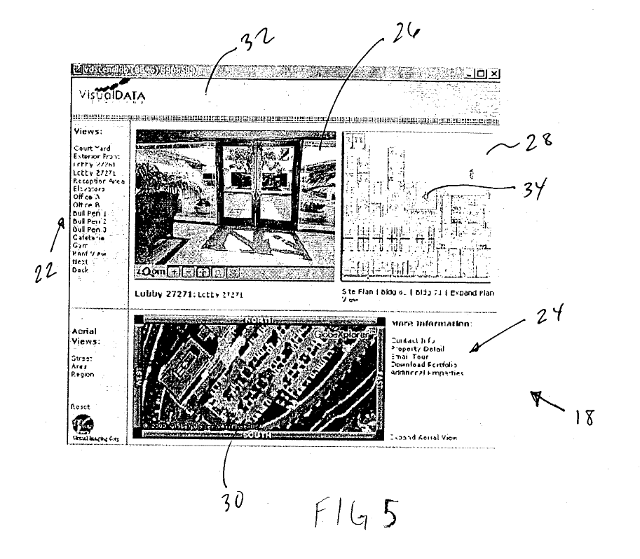

Now referring to FIG. 5, when “Lobby 27271” option is selected from first set of command options 22, the view presented in first presentation window 26 reflects the same. As a result, second presentation window 26 retrieves the corresponding view of the floor plan, site plan, an elevation, a stacking plan or other drawings or renderings from the data base and presents the same. In addition, third presentation window 30 also retrieves the corresponding “zoom-in” view of the aerial photograph and presents the same.

While the above description contains many specificities, these should not be construed as limitations on the scope of the invention, but rather as an exemplification of one preferred embodiment thereof. Many other variations are possible without departing from the essential spirit of this invention. Accordingly, the scope of the invention should be determined not by the embodiment illustrated, but by the appended claims and their legal equivalents.

What is claimed is:

1. A data processing display system comprising:
an interface on a display for displaying data;
a data processing system coupled to said display, said data processing system displaying data in at least one window on said interface;
a selection device coupled to said data processing system for selecting data by a user;
whereby, selection of specific data provides information regarding a specific real property.

2. The system of claim 1, wherein said interface further comprises a first presentation window, a second presentation window, and a third presentation window that provide interrelated data regarding said real property.
